(19) United States
(12) Patent Application Publication
(10) Pub. No.: US 2005/0277013 A1
(43) Pub. Date: Dec. 15, 2005

(54) Solid polymer type fuel cell, metal separator for fuel cell, and kit for fuel cell

(76) Inventors: Kenji Yamaga, Hitachi (JP); Hiroshi Yamauchi, Hitachi (JP); Kou Takahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/151,251

(22) Filed: Jun. 14, 2005

(30) Foreign Application Priority Data
Jun. 14, 2004 (JP) 2004-175202

(51) Int. Cl. H01M 8/02; H01M 8/10; H01M 4/94

(52) U.S. Cl. 429/38; 429/44; 429/30

(57) ABSTRACT

The present invention provides a fuel cell employing a metal separator in which low gas pressure loss, high hydrogen utilization factor operation and long term power generation are possible. The fuel cell according to the present invention is constituted by laminating a plurality of units, the units combining a metal gas channel plate having on both faces a frame portion and a plurality of gas channel sets formed inside the frame portion, a frame having a supply manifold for supplying reaction gas to an end turn-around portion of the gas channels closely attached to the frame portion of the above described metal gas channel plate and a discharge manifold for discharging reaction gas, a reaction gas diffusion layer in contact with the above described frame, an electrolyte membrane which is in contact with the above described diffusion layer and in which one side is in contact with an anode and another side in contact with a cathode, a reaction gas diffusion layer in contact with the above described anode or the above described cathode, the above described metal gas channel plate and the above described frame, wherein a plurality of supply manifolds and/or discharge manifolds are provided per each frame.

### INCORPORATION BY REFERENCE

The present application claims priority from Japanese application JP 2004-175202 fled on Jun. 14, 2004, the content of which is hereby incorporated by reference into this application.

### BACKGROUND OF THE INVENTION

The present invention relates to a polymer electrolyte fuel cell capable of extracting energy from a fuel and an oxidant by means of an electrochemical reaction, a metallic separator for a fuel cell, and a kit for a fuel cell.

Polymer electrolyte fuel cells which use a proton-conducting polymer film as an electrolyte are a power generating system that is currently being researched. However, one problem to be resolved for practical use is high material costs. One of the high-cost materials which constitute a fuel cell is a separator. A separator segregates two reaction gases so that they do not mix, and is a term for an electron-conducting plate that is provided with gas channel grooves. When a fuel cell is generating power, the internal environment of the fuel cell is corrosive, so that the separator needs to possess high corrosion resistance. In addition, the separator material must also possess characteristics such as structural strength, gas impermeability and low resistance.

For this reason, at present, materials which are employed as the separator material include a fine graphite plate having gas channels worked therein or a molded graphite separator in which gas channels are formed on resin molded graphite produced by aggregating artificial graphite particles with a resin. Another possibility for reducing costs lies in a separator which employs a metallic material. Since metallic materials have high strength, walls can be made thinner, and workability is good. Such points enable material costs and processing costs per separator to be drastically reduced. Normally, metallic materials produce corrosive matter under fuel cell power generating conditions. However, metal separators are now being developed with corrosion resistance that has been improved by forming a unique material onto the surface or coating a conductivity-protection paste onto the surface. Such technology is, for example, disclosed in JP-A-2003-272659 and JP-A-2003-193206.

Since a carbon separator possesses a plate thickness of about at least 2 mm, the front and back gas channels may be formed independently. However, because the gas channels in a metal separator are made by pressing a plate having a thickness of 0.5 mm or lower, gas channel ridges and grooves can be formed which reflect the shape of the front of the plate on the back. When a plurality of metal plates are stacked together to form a separator, the front and back gas channel shape are independent of each other, although the cost increases.

The cheapest way of forming a separator is to form a separator from a single metal plate. In such a case, because the gas channels are formed using the front and back of the gas channel-formed plate, gas channels are formed only on the portion common to the front and back. For instance, if a conducting gas channel portion which conducts gas from the manifold to the electrode surface is press-molded to the metal plate, gas from the manifold flows into both the front and back of a single separator, rendering power generation impossible. Thus, it is difficult in a metal plate to form the gas channels which connect the manifold with the electrode surface. In this case, it is necessary to form the gas channels from a material different from that of the metal separator. Since a separator must also have function for sealing the gas, if the material for sealing is formed into the shape of the above described gas channel, the separator can be formed by the metal plate and the sealing material.

For a gas channel formed on a metal plate that is common to the front and back, the shape that is the easiest to form is a plurality of linear gas channels. Plural linear gas channels have a gas channel cross-sectional area in which gas flows greater than that of, for example, a serpentine gas channel shape. When the gas channel cross-sectional area is large, if an identical amount of gas is supplied the distance that the gas travels per unit time is relatively less. Thus, condensed moisture in the fuel cell and the formed moisture generated from the electrochemical reaction are not discharged by the gas flow and may accumulate in the fuel cell. Since water that has accumulated in the fuel cell disrupts the diffusion of reaction gas to the electrode reaction field, the result is that fuel cell performance may become unstable.

In view of this, gas flow structures are being considered in which gas channels are partially formed on a structural body, such as a resin or sealing material, and the gas progression direction is made to turn at gas channel portions formed on the resin while using a plurality of linear gas channels formed on the metal plate, to thereby overall conform to a serpentine gas channel shape.

### SUMMARY OF THE INVENTION

In the above described technology, however, since gas flowing from the gas channel portion concentrates at the turn-around portions where the gas is made to turn, this results in the problem that the gas pressure loss is large. For laminar flow, pressure loss is a value proportional to gas viscosity, gas flow rate and the gas channel length, and inversely proportional to the square of the gas channel cross-sectional equivalent diameter. In a fuel cell power generation system, if the gas pressure loss value of the fuel cell is large, a high blow pressure air blower has to be employed, thus increasing the ancillary machinery losses. As a result, efficiency as a power generation system decreases.

While it is possible to increase the cross-sectional area of the gas channels which form the separator in order to mitigate pressure loss, since single cells are of a thin type, it is almost impossible to increase their dimension in the thickness direction. This means, therefore, that either the width of the gas channels is expanded or the plurality of gas channels is increased in number. However, such measures result in an increase in the portion not contributing to power generation, thereby reducing the electrical energy which can be extracted in relation to fuel cell volume. Thus, for a fuel cell designed to use a metal separator constituted from a separator which uses a single metal gas channel plate, it is difficult to reduce pressure loss while maintaining a high electrical energy amount in relation to fuel cell volume.

According to the present invention, a fuel cell is provided which is constituted by laminating a plurality of units, the units combining a first metal gas channel plate having on both faces a frame portion and a plurality of gas channel sets formed inside the frame portion, a first frame having a supply manifold for supplying reaction gas to an edge turn-around portion of the gas channels closely attached to the frame portion of the above described metal gas channel plate and to the gas channels and a discharge manifold for discharging reaction gas, a first reaction gas diffusion layer in contact with the above described frame, an electrolyte membrane which is in contact with the above described first reaction gas diffusion layer wherein one side is in contact with an anode and another side with a cathode, a second reaction gas diffusion layer in contact with the above described anode or the cathode, a second frame in contact with the above described second reaction gas diffusion layer, and a second metal gas channel plate, wherein a plurality of supply manifolds and/or discharge manifolds are provided per each frame.

In the above described above described structure, the first and second reaction gas diffusion plates have substantially the same structure and function, although they have been differentiated in order to provide a clear distinction. The same also applies to the first and second frames.

The present invention also provides a separator for a fuel cell, which comprises a metal gas channel plate having on both faces a frame portion and a plurality of gas channel sets formed inside the frame portion, and a frame having a supply manifold for supplying reaction gas to an end turn-around portion of the gas channels closely attached to the frame portion of the above described metal gas channel plate and to the gas channels and a discharge manifold for discharging reaction gas, wherein a plurality of supply manifolds and/or discharge manifolds are provided per each frame.

The present invention further provides a kit for a fuel cell, which comprises a metal gas channel plate having on both faces a frame portion and a plurality of gas channel sets formed inside the frame portion, a frame having a supply manifold for supplying reaction gas to an end turn-around portion of the gas channels closely attached to a frame portion of the above described metal gas channel plate and to the gas channels and a discharge manifold for discharging reaction gas, a reaction gas diffusion layer, and a membrane electrode assembly which has an electrolyte membrane in contact with an anode on one side and a cathode on another side, wherein a plurality of supply manifolds and/or discharge manifolds are provided per each frame. This kit is a product which brings together the necessary elements for assembling a fuel cell in a single or a plurality of sets. Therefore, the kit can naturally contain additional elements as required such as a casing, end plates, a clamping device and the like.

According to the present invention, gas distribution channel groups in the cell can be divided into a plurality by making the number of supply manifolds and/or discharge manifolds to be plural in number. Further, the gas velocity can be suppressed at the gas turn-around portions by reducing the gas amount in relation to the distribution channels, to thereby reduce pressure loss.

Other objects, features and advantages of the invention will become apparent from the following description of the embodiments of the invention taken in conjunction with the accompanying drawings.

### BRIEF DESCRIPTION OF THE DRAWINGS

FIG. 1 is a developed view illustrating the main structure of a fuel cell generating portion which employs a separator according to the present invention;

FIG. 2 is a plan view of the cathode separator according to Example 1;

FIG. 3 is a plan view of the cathode separator according to Example 2;

FIG. 4 is a plan view of the cathode separator according to Example 3;

FIG. 5 is a plan view of the anode separator according to Example 4; and

FIG. 6 is a plan view of the anode separator according to the Comparative Example.

### DESCRIPTION OF REFERENCE NUMERALS

1 metal gas channel plate
2 cathode-side frame
3 anode-side frame
4 cathode gas diffusion layer
5 electrolyte membrane
6 anode gas diffusion layer
7 anode
8 membrane electrode assembly
9 linear ridge/groove-shaped gas channel
10 cathode gas supply manifold aperture
11 cathode gas discharge manifold aperture
12 cathode turn-around portion
13 cathode frame gas channel portion
15 anode gas supply manifold aperture
16 anode gas discharge manifold aperture
17 anode turn-around portion
18 anode frame gas channel portion
20 cooling fluid manifold aperture
31 gas distribution channel A
32 gas distribution channel B
40 linear gas channel portion A1
41 linear gas channel portion A2
42 linear gas channel portion A3
43 linear gas channel portion A4
44 linear gas channel portion A5
45 linear gas channel portion B1
46 linear gas channel portion B2
47 linear gas channel portion B3
48 linear gas channel portion B4
49 linear gas channel portion B5

### DETAILED DESCRIPTION OF THE INVENTION

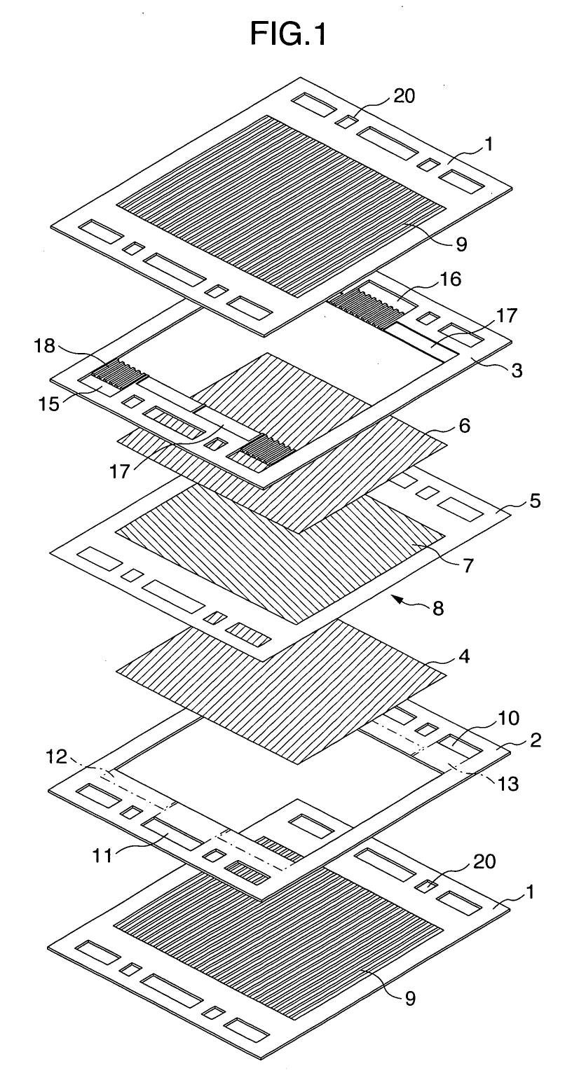

Various embodiments of the present invention will now be explained. First, an overall explanation will be made with reference to FIG. 1. FIG. 1 illustrates a unit consisting of a metal gas channel plate 1, a cathode-side frame 3, a cathode-side reaction gas diffusion layer 6, a membrane electrode assembly 8, an anode-side reaction gas diffusion layer 4, an anode-side frame 2 and an anode-side metal gas channel plate 1. A plurality of units is stacked to thereby constitute a fuel cell having a desired voltage.

In the present specification and patent claims, for ease of expression the cathode-side metal gas channel plate and frame are written as respectively a “first metal gas channel plate” and a “first frame”, while the anode-side metal gas channel plate and frame are written as respectively a “second metal gas channel plate” and a “second frame”. However, this is not to say that the cathode side is “first”, while the anode side is “second”. Further, as illustrated in FIG. 1, a protruding portion 18 is formed on a fold of the surface of the side in contact with the frame. Plastic is preferable as the material for the frame, in view of workability, cost and other features. However, because plastic is flexible, when the metal gas channel plate is crimped to the frame, the frame is squeezed, whereby there is a risk that the frame fold gas channels may collapse. The protruding portions are intended to resolve this problem. However, the side opposite to the surface on which the protruding portions are formed is smooth, thus requiring close attachment with the reaction gas diffusion layer and membrane electrode assembly.

A main characteristic feature of the present invention will now be described. A metal separator is employed in which a metal gas channel plate formed by pressing a metal plate to have a plurality of preferably linear ridge/groove-shapes is integrated with a frame which ensures that the reaction gas is sealed against the exterior by close-attachment to the metal gas channel plate, which is itself formed with a gas channel for partially distributing gas, and which forms a supply manifold for supplying reaction gas to each single cell and a discharge manifold for discharging the reaction gas when laminated to form a stack comprising a plurality of single cells. As this metal separator, a metal separator is employed which is formed using a frame in which the number Nf of supply manifolds for supplying reaction gas to the metal gas channel plate is defined by Nf=2n (where n is a natural number).

The above described supply manifold is, when viewed with the above described gas channel sets in a flat plane, formed on the same gas channel edge side and separately on the left and right therefrom. The supply manifold may be located in a roughly central portion of the above described gas channel plate, and the above described discharge manifold formed on an opposite side of the gas channel edge to the supply manifold and separately on the left and right therefrom when viewed with the gas channel sets in a flat plane.

A plurality of supply manifolds may be formed on the same gas channel edge, while a plurality of discharge manifolds may be formed on an opposite side to such gas channel edge. The supply manifolds and discharge manifolds may also be formed all on the same gas channel edge.

The present invention also provides a fuel cell which is formed from a basic structure comprising a metal separator in which a metal gas channel plate formed by pressing a metal plate to have a plurality of preferably linear ridge/groove-shapes is integrated with a frame which ensure that the reaction gas are sealed against the exterior by close-attachment to the metal gas channel plate, which is itself formed with a gas channel for partially distributing gas, and which forms manifolds for supplying and discharging reaction gas to each single cell when laminated to form a stack comprising a plurality of single cells, an electrolyte membrane formed with an anode and a cathode on a front and back thereof, and a diffusion layer for evenly diffusing the supplied reaction gas to the electrodes, wherein the fuel cell employs a metal separator formed using a frame in which the number Nf of supply manifolds for supplying reaction gas to the metal gas channel plate is defined by Nf=2n (where n is a natural number).

On the above described frame which is closely attached to the metal separator, the ends of a plurality of linear ridge/groove-shaped gas channels formed on the metal gas channel plate are spatially connected to the ends of a plurality of separate and adjacent linear ridge/groove-shaped gas channels, and gas turn-around portion shapes are formed for conducting reaction gas flowing through the linear ridge/groove-shaped gas channels to the adjacent plurality of ridge/groove-shaped gas channels. A metal separator is preferably used in which the number Nt of these turn-around portions is defined by Nt=2m (where m is a natural number) per separator.

A metal separator can be used in which the number Nfi of manifolds for supplying reaction gas to the linear ridge/groove-shaped gas channels of the above described metal gas channel plate is, with respect to the number Nfo of manifolds for discharging gas from the linear ridge/groove-shaped gas channels, defined by Nfi−Nfo≧1.

Further, a metal separator can be used in which the number Nta of turn-around portions per separator which are formed on the anode gas channel and the number Ntc of turn-around portions per separator which are formed on the cathode gas channel is defined by Nta>Ntc. In addition, if the linear ridge/groove-shaped gas channels formed on the metal gas channel plate which constitutes the metal separator are disposed horizontally at least during power generation, the adverse effects of condensed water can be prevented.

In the above described separator for a fuel cell, when viewed with the above described gas channel sets in a flat plane, the supply manifold can be formed on the same gas channel edge side and separately on the left and right therefrom. Further, the above described supply manifold may be located in a roughly central portion of the above described gas channel plate, and the above described discharge manifold formed on an opposite side of the gas channel edge to the supply manifold and separately on the left and right therefrom when viewed with the above described gas channel sets in a flat plane. It is preferable to form a plurality of supply manifolds on a same gas channel edge, and a plurality of discharge manifolds on an opposite side to such gas channel edge. The supply manifolds and discharge manifolds may also be formed all along the same gas channel edge.

In the above described kit for a fuel cell, when viewed with the above described gas channel sets in a flat plane, the above described supply manifold can be formed on the same gas channel edge side and separately on the left and right therefrom. Further, the supply manifold may be located in a roughly central portion of the above described gas channel plate, and the above described discharge manifold formed on an opposite side of the gas channel edge to the supply manifold and separately on the left and right therefrom when viewed with the above described gas channel sets in a flat plane. A plurality of supply manifolds can be formed on a same gas channel edge, and a plurality of discharge manifolds can be formed on an opposite side to such gas channel edge. The supply manifolds and discharge manifolds may also be formed all along the same gas channel edge.

According to the present invention, when the number of supply manifolds is 2, for example, there are 2 gas channels (i.e. gas distribution channels) which flow between the discharge manifold and the supply manifold in the single cell. This means that the gas amount per distribution channel is half that of the case where there is only one channel. When there is half the gas amount, even if the gas channel width per distribution channel is designed to be halved, pressure loss does not increase since the apparent flow rate is the same.

If the cross-sectional area of the gas turn-around portions is made to be the same, the pressure loss value when the gas amount is halved can be reduced. In addition, if 2 distribution channels are provided, the gas amount is one-half, which means that the reaction portion gas channel width can be narrowed, and the gas channel length of the turn-around portions which spatially connect the reaction portion gas channel ends can be reduced. This in turn allows the pressure loss value of the turn-around portions to be reduced by the amount that the distribution channels were increased.

That is, because the gas distribution channels in the fuel cell are split into two, the pressure loss value per distribution channel can be reduced in relation to the gas amount. This effect is especially large for the turn-around portions. Since the distribution channels are parallel in the fuel cell, the fuel cell pressure loss is not cumulative, whereby a dramatic reduction is possible.

The present invention further provides a metal separator, in which the ends of a plurality of linear ridge/groove-shaped gas channels formed on a metal gas channel plate are spatially connected to the ends of a plurality of separate and adjacent linear ridge/groove-shaped gas channels, and gas turn-around portion shapes are formed on a frame for conducting reaction gas flowing through the linear ridge/groove-shaped gas channels to the adjacent plurality of ridge/groove-shaped gas channels, wherein the number Nt of the turn-around portions is defined by Nt=2m (where m is a natural number) per separator.

Since the gas channels formed on the metal plate are linear, if the gas channel fold number is set to be an even number, the supply and discharge manifolds can be naturally positioned in a vicinity which faces the electrode surface. For example, if the fold number is an odd number, a disparity develops between the gas channel length that includes the turn-around portion of the gas flowing through the outermost side with that of the gas flowing through the innermost side gas channel. This causes a difference in gas channel resistance, so that the gas amount differs depending on the gas channel, whereby uniform gas flow on the electrode surface cannot be achieved. Accordingly, by setting the fold number to be an even number, the gas flow on the electrode surface can be made uniform, which can contribute to the stabilization of fuel cell performance.

The present invention further provides a metal separator in which the number Nfi of manifolds for supplying reaction gas to the linear ridge/groove-shaped gas channels of a metal gas channel plate is, with respect to the number Nfo of manifolds for discharging gas from the linear ridge/groove-shaped gas channels, defined by Nfi−Nfo>1.

In the separator, when the fold number per gas distribution channel is taken to be n, the linear gas channel portion which is formed into a serpentine can be divided into n+1 portions. If the respective linear gas channel portions of the distribution channel r are taken to be r₁, r₂, . . . rₙ₊₁, the gas supplied from the manifold flows through r₁, while at the discharge manifold the gas flows from rₙ₊₁.

When a plurality of the above described gas channels are combined, pressure loss can be reduced as the gas amount flowing to the turn-around portions decreases. Various techniques exist for combining the gas channels, wherein when r₁ is adjacent to a linear gas channel portion r′ₙ₊₁ of a distribution channel r′ (different to r), there is the possibility that the gas flowing through r₁ may flow into the r′ₙ₊₁ gas channel. In such a case, gas is led from the r′ₙ₊₁ gas channel to the discharge manifold, whereby reaction gas that was supposed to be for the electrochemical reaction is directly discharged. Therefore, r₁ and r′ₙ₊₁ are preferably disposed apart from each other.

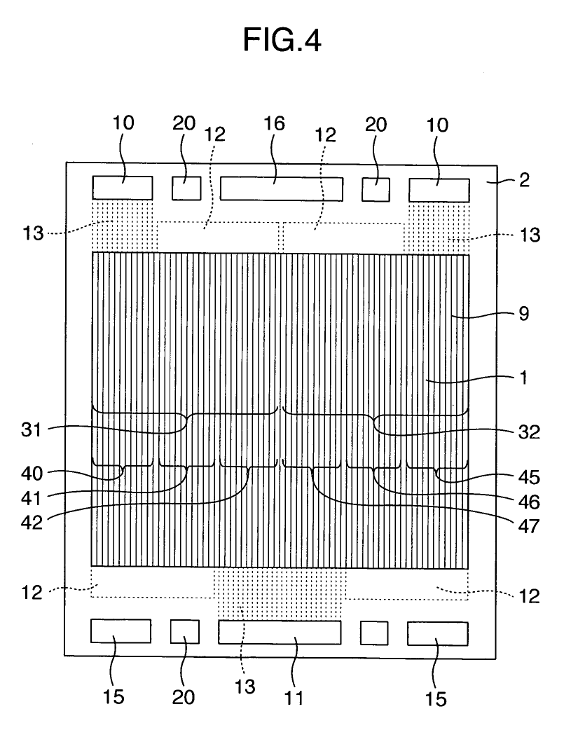

If r₁ and r′₁, are adjacent, there is no problem with the reaction even if the gas flows into the adjacent gas channel. However, since r₁ and r′₁ are in a state wherein the hydrogen concentration is at its highest and most reactive, if positioned in the center of the electrode the generated heat increases, whereby the temperature rise of the center is marked. Thus it is preferable in terms of heat distribution within the electrode surface that r₁ is located to be on an edge portion of the gas channel. In such a case, integrating the discharge manifolds being conducted to from the adjacent rₙ₊₁ and r′ₙ₊₁ gas channels into a single manifold is effective for managing loss reduction of reaction gas and fuel cell temperature during power generation and for simplification of the gas seal structure. FIG. 4 illustrates a separator when Nfi=2, Nfo=1 and n=2.

The present invention further provides a fuel cell which employs a metal separator in which the number Nta of turn-around portions per separator which are formed on an anode gas channel and the number Ntc of turn-around portions per separator which are formed on a cathode gas channel is defined by Nta>Ntc.

Since the anode gas usually improves power generation efficiency more than the cathode gas, the anode gas utilization factor is set to be higher. The term “utilization factor” as used here is defined as the ratio of the amount of gas consumed by power generation versus the amount of gas supplied. Thus, regarding the anode gas amount and the cathode gas amount during power generation, the cathode gas amount larger in absolute terms. When the fuel cell gas channels have the same construction for the cathode and the anode, the cathode gas pressure loss is larger. The corollary is that this means the anode gas flow rate is relatively low.

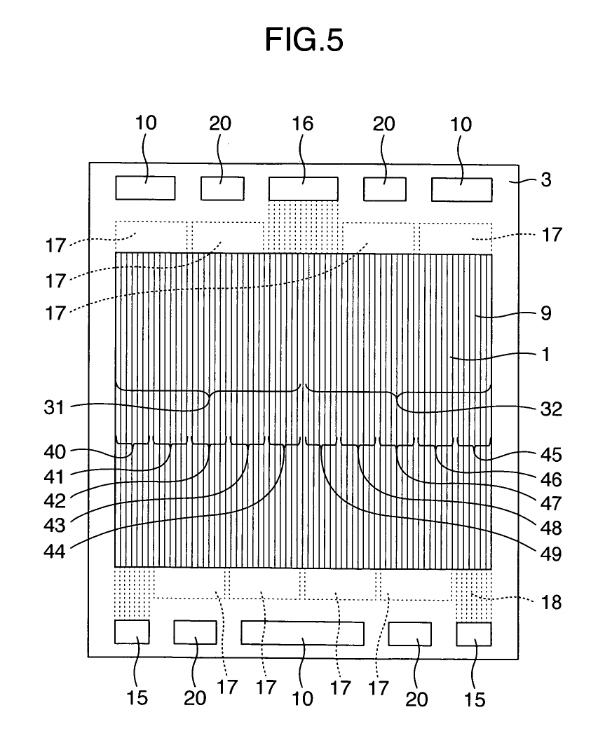

The anode supply gas is made to contain water vapor for the purpose of humidifying the electrolyte membrane. However, if the gas amount decreases from of power generation, supersaturated moisture condenses, a part of which turns into droplets. This hinders gas diffusion, which interferes with the power generation reaction. It is therefore necessary to set the anode gas to a high flow rate for blowing off moisture. The gas channel shape and gas channel depth is the same for the anode and cathode gases due to the fact that the front and back of a press-metal plate are shared. If the fold number of the anode gas can be increased to narrow the width of the gas flow, the anode gas flow rate can be improved and stable fuel cell performance is possible. FIG. 5 illustrates a separator in which Nta=8 and Ntc=4.

The present invention further provides a fuel cell which employs a metal separator in which the linear ridge/groove-shaped gas channels formed on the metal gas channel plate which constitutes the metal separator are disposed horizontally at least during power generation.

If the gas flow in the fuel cell is designed so as to be upwards against gravity, the flow of condensed moisture is slowed down, whereby there is a possibility that diffusion of the reaction gas may be obstructed. Especially when generating power with a high current density, because a large amount of gas is consumed and a large amount of water produced, there is a high risk that fuel cell performance will become unstable. In contrast, in the gas channels according to the present invention, if the electrode surface is set to be perpendicular, the gas channels form a portion which turns upward. Therefore, if adjacent gas channels are provided to be on the horizontal surface, rapid discharge is possible without condensed moisture accumulating in the electrode surface gas channels. If the discharge direction of the manifold is set in the direction of gravity, the discharge of moisture from the stack will not be slowed down, and is thus further preferable.

### Description of Preferred Embodiment

Embodiments of the present invention will now be described with reference to the below examples.

### EXAMPLE 1

A 0.15 mm-thick stainless steel sheet having press-molded thereon 31 linear ridge/groove-shaped gas channels which had a gas channel pitch of 3 mm and an overhang of 0.3 mm was made to serve as a metal gas channel plate 1. On a 0.5 mm-thick sheet of PPS (polyphenylenesulfide) in which portions corresponding to the linear gas channels were in a hollowed out frame-shape, a cathode-side frame 2 was formed comprising a cathode gas supply manifold aperture 10, a cathode gas discharge manifold aperture 11, an anode gas supply manifold aperture 15, an anode gas discharge manifold aperture 16, a cathode turn-around portion 12, and three each of gas distribution channels A31 and distribution channels B32 for a total of 6 channels. The metal gas channel plate 1 and the frame 2 were adhered together using a liquid-state gasket so that there were no gaps therebetween, to thereby fabricate a cathode separator.

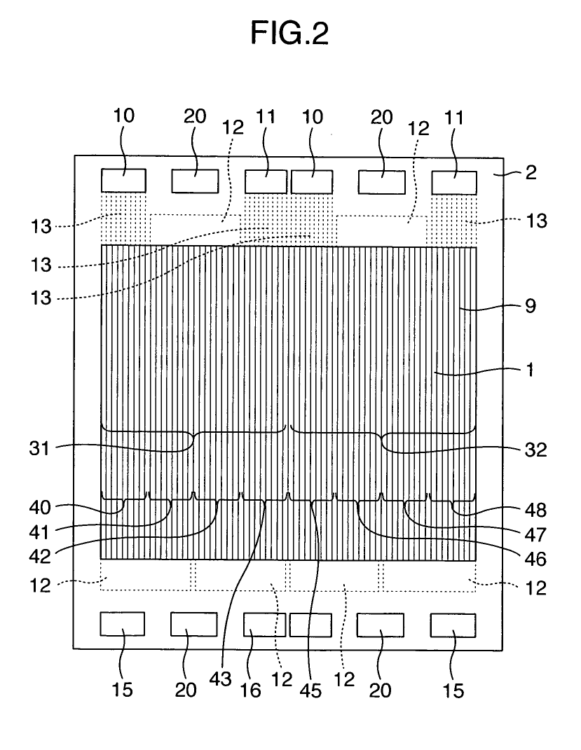

An external view of the cathode separator is illustrated in FIG. 2. In this cathode separator, there are two gas distribution channels, gas distribution channel A31 and distribution channel B32, formed by the linear ridge/groove-shaped gas channels through which gas flows in the supply manifold, the discharge manifold and therebetween. Since each of the distribution channels 31 and 32 has 3 turn-around portions, each of the distribution channels is constituted from 4 linear gas channel portions. Therefore, the gas supplied from the cathode gas supply manifold aperture 10 flows through the cathode frame gas channel portion 13, and for the distribution channel A31, gas is discharged to the cathode gas discharge manifold aperture 11 via the linear gas channel portion A140, the cathode turn-around portion 12, the linear gas channel portion A241, the cathode turn-around portion 12, the linear gas channel portion A342, the cathode turn-around portion 12, the linear gas channel portion A443 and the cathode frame gas channel portion 13.

In the same manner, for the distribution channel B32, gas is discharged to the cathode gas discharge manifold aperture 11 via the linear gas channel portion B145, the cathode turn-around portion 12, the linear gas channel portion B246, the cathode turn-around portion 12, the linear gas channel portion B347, the cathode turn-around portion 12, the linear gas channel portion B448 and the cathode frame gas channel portion 13. An anode separator was fabricated using the same materials and in the same manner.

A 5% by weight Nafion-alcohol solution in which the electrolyte content corresponded to 60 wt % by dry weight of the catalyst content was added onto a carbon supported platinum-ruthenium catalyst and mixed into a paste. This paste was applied onto an electrolyte membrane 5 of Nafion (registered trademark, hereinafter the same) 112 which had been subjected to protonation treatment, and subjected to drying for 3 hours at 60° C., to thereby form an anode 7. The obtained anode 7 supported platinum amount was 0.5 mg/cm² and supported ruthenium amount was 0.5 mg/cm². A Nafion-alcohol solution in which the Nafion content corresponded to 60 wt % by dry weight of the catalyst content was added onto a carbon supported platinum powdered catalyst and mixed into a paste. This paste was applied onto a face of the opposite side of the formed electrolyte membrane 5, and dried at 60° C. for 3 hours so that the thickness when dried was 15 μm, to thereby for a cathode, to thereby fabricate a membrane electrode assembly.

The obtained cathode 7 supported platinum amount was 0.3 mg/cm². The dried junction was soaked for 8 hours in 1 M sulfuric acid, well-washed with water and then allowed to dry in air to yield a membrane electrode assembly that had been subjected to protonation.

The anode separator, cathode separator, membrane electrode assembly, a cathode diffusion layer 4, which was a carbon paper which had its water-repellency controlled by having polytetrafluoroethylene (PTFE) dispersed on its surface, an anode diffusion layer 6 and a cooling separator were laminated, and an end plate was tightened with a bolt to thereby form a single cell.

The cell was arranged so that the separator gas channels in the fabricated single cell were perpendicular. A modified simulation gas having a 0.5 hydrogen concentration as the anode gas and air as the cathode gas were each bubbled through a bubbler set to 60° C. to add a certain amount of water vapor for supply to the single cells. A current set at a current density of 0.3 A/cm² was applied using an electron load device, and a power generation test was carried out. Water that could be controlled was supplied to the cooling cell at 0.1 L/min at an arbitrary temperature, whereby the until cell temperature was controlled so that power generation could be carried out in a range of from 70 to 73° C. The single cell temperature was measured using a separately-provided fuel cell temperature measuring port to measure the electrode central portion temperature of the power generation separator. The gas pressure loss was measured by providing a pressure gauge on the single cell entrance portion of the supplying gas line, and defining the pressure difference (differential pressure) during power generation as respectively the anode pressure loss and the cathode pressure loss.

### EXAMPLE 2

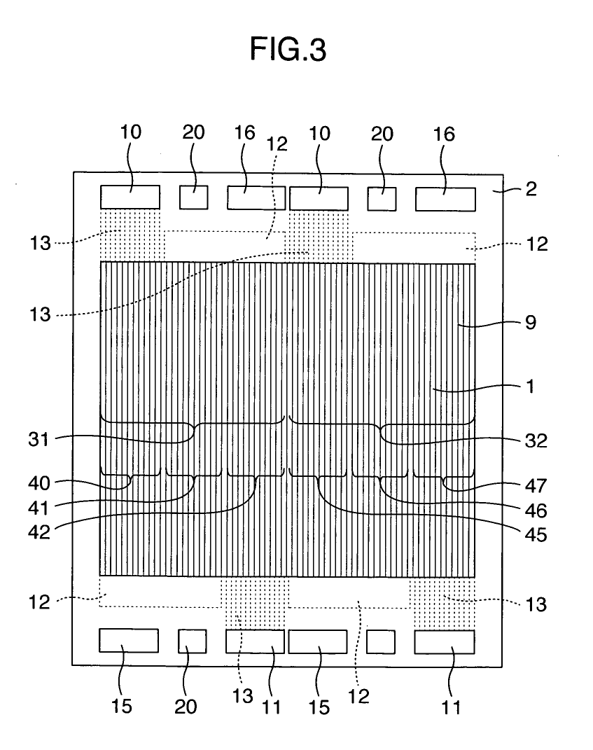

A cathode-side frame 2 was formed comprising a cathode gas supply manifold aperture 10, a cathode gas discharge manifold aperture 11, an anode gas supply manifold aperture 15, an anode gas discharge manifold aperture 16, a cathode turn-around portion 12, and two each of gas distribution channels A31 and distribution channels B32 for a total of 4 channels. A metal gas channel plate 1 having linear ridge/groove-shaped gas channels 9 and the frame 2 were adhered together using a liquid-state gasket so that there were no gaps therebetween, to thereby fabricate a cathode separator. An external view of the cathode separator is illustrated in FIG. 3.

In this cathode separator, there are two gas distribution channels, gas distribution channel A31 and distribution channel B32, formed by the linear ridge/groove-shaped gas channels through which gas flows in the supply manifold, the discharge manifold and therebetween. Since each of the distribution channels 31 and 32 has 2 turn-around portions, each of the distribution channels is constituted from 3 linear gas channel portions. Therefore, the gas supplied from the cathode gas supply manifold aperture 10 flows through the cathode frame gas channel portion 13, wherein for the distribution channel A31, gas is discharged to the cathode gas discharge manifold aperture 11 via the linear gas channel portion A140, the cathode turn-around portion 12, the linear gas channel portion A241, the cathode turn-around portion 12, the linear gas channel portion A342 and the cathode frame gas channel portion 13. In the same manner, for the distribution channels B32, gas is discharged to the cathode gas discharge manifold aperture 11 via the linear gas channel portion B145, the cathode turn-around portion 12, the linear gas channel portion B246, the cathode turn-around portion 12, the linear gas channel portion B347 and the cathode frame gas channel portion 13. An anode separator was fabricated using the same materials and in the same manner. The single cell was then assembled and power generation evaluation was carried out in the same manner as that in Example 1.

### EXAMPLE 3

A cathode-side frame 2 was formed comprising a cathode gas supply manifold aperture 10, a cathode gas discharge manifold aperture 11, an anode gas supply manifold aperture 15, an anode gas discharge manifold aperture 16, a cathode turn-around portion 12, and two each of gas distribution channels A31 and distribution channels B32 for a total of 4 channels. A metal gas channel plate 1 having linear ridge/groove-shaped gas channels 9 and the frame 2 were adhered together using a liquid-state gasket so that there were no gaps therebetween, to thereby fabricate a cathode separator. An external view of the cathode separator is illustrated in FIG. 4.

In this cathode separator, there are two gas distribution channels, gas distribution channel A31 and distribution channel B32, formed by the linear ridge/groove-shaped gas channels through which gas flows in the supply manifold, the discharge manifold and therebetween. Since each of the distribution channels 31 and 32 has 2 turn-around portions, each of the distribution channels is constituted from 3 linear gas channel portions. Therefore, the gas supplied from the cathode gas supply manifold aperture 10 flows through the cathode frame gas channel portion 13, wherein for the distribution channel A31, gas is discharged to the cathode gas discharge manifold aperture 11 via the linear gas channel portion A140, the cathode turn-around portion 12, the linear gas channel portion A241, the cathode turn-around portion 12, the linear gas channel portion A342 and the cathode frame gas channel portion 13. In the same manner, for the distribution channel B32, gas is discharged to the cathode gas discharge manifold aperture 11 via the linear gas channel portion B147, the cathode turn-around portion 12, the linear gas channel portion B246, the cathode turn-around portion 12, the linear gas channel portion B345 and the cathode frame gas channel portion 13.

An anode separator was fabricated using the same materials and in the same manner. A single cell was then assembled and power generation evaluation was carried out in the same manner as that in Example 1. A power generation portion structural diagram for when the present separator was used is illustrated in FIG. 1.

### EXAMPLE 4

An anode-side frame 3 was formed comprising an anode gas supply manifold aperture 15, an anode gas discharge manifold aperture 16, a cathode gas supply manifold aperture 10, a cathode gas discharge manifold aperture 11, an anode turn-around portion 17, and four each of gas distribution channels A31 and distribution channels B32 for a total of 8 channels. A metal gas channel plate 1 having linear ridge/groove-shaped gas channels 9 and the frame 3 were adhered together using a liquid-state gasket so that there were no gaps therebetween, to thereby fabricate a anode separator. An external view of the anode separator is illustrated in FIG. 5.

In this anode separator, there are two gas distribution channels, gas distribution channel A31 and distribution channel B32, formed by the linear ridge/groove-shaped gas channels through which gas flows in the supply manifold, the discharge manifold and therebetween. Since each of the distribution channels 31 and 32 has 4 turn-around portions, each of the distribution channels is constituted from 5 linear gas channel portions. Therefore, the gas supplied from the anode gas supply manifold aperture 15 flows through the anode frame gas channel portion 18, wherein for the distribution channel A31, gas is discharged to the anode gas discharge manifold aperture 16 via the linear gas channel portion A140, the anode turn-around portion 17, the linear gas channel portion A241, the anode turn-around portion 17, the linear gas channel portion A342, the anode turn-around portion 17, the linear gas channel-portion A443, the anode turn-around portion 17, the linear gas channel portion A544 and the anode frame gas channel portion 18.

In the same manner, for the distribution channel B32, gas flows through the anode frame gas channel portion 18 and is discharged to the anode gas discharge manifold aperture 16 via the linear gas channel portion B149, the anode turn-around portion 17, the linear gas channel portion B248, the anode turn-around portion 17, the linear gas channel portion B347, the anode turn-around portion 17, the linear gas channel portion B446, the anode turn-around portion 17, the linear gas channel portion B545 and the anode frame gas channel portion 18. A single cell was fabricated using this anode separator and the cathode separator from Example 3. The fabricated cell was subjected to a power generation evaluation in the same manner as that in Example 1.

### EXAMPLE 5

Using the single cell according to Example 4, evaluation was carried out in the same manner as that in Example 4, except that the single cell was disposed so that the separator gas channels were horizontal.

### COMPARATIVE EXAMPLE

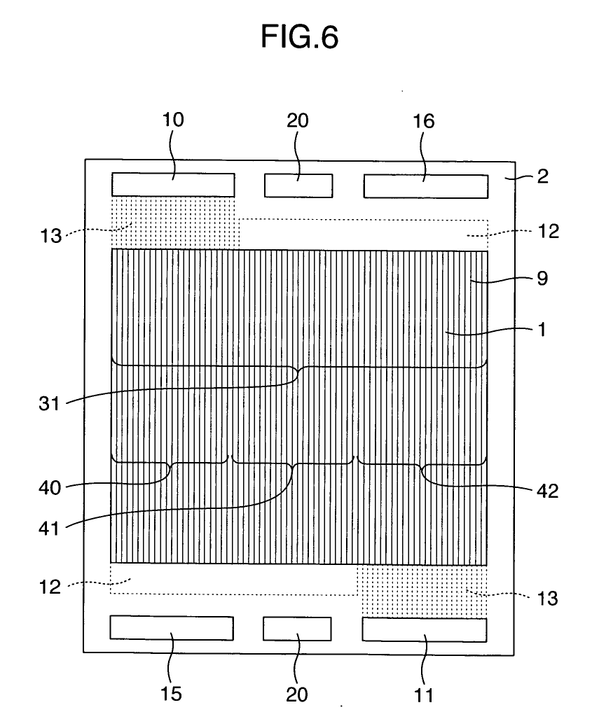

A cathode-side frame 2 was formed comprising a cathode gas supply manifold aperture 10, a cathode gas discharge manifold aperture 11, an anode gas supply manifold aperture 15, an anode gas discharge manifold aperture 16, a cathode turn-around portion 12, and two gas distribution channels A31. A metal gas channel plate 1 having linear ridge/groove-shaped gas channels 9 and the frame 2 were adhered together using a liquid-state gasket so that there were no gaps therebetween, to thereby fabricate a cathode separator. An external view of the cathode separator is illustrated in FIG. 6.

This cathode separator comprised one gas distribution gas channel formed by linear ridge/groove-shaped gas channels through which gas flows through the supply manifold, the discharge manifold and therebetween, and two turn-around portions, so that the distribution channel was constituted from 3 linear gas channel portions. Thus, gas supplied from the cathode gas supply manifold aperture 10 flows through the cathode frame gas channel portion 13, wherein gas is discharged to the cathode gas discharge manifold aperture 11 via the linear gas channel portion A140, the cathode turn-around portion 12, the linear gas channel portion A241, the cathode turn-around portion 12, the linear gas channel portion A342 and the cathode frame gas channel portion 13. An anode separator was fabricated using the same materials and in the same manner. A single cell was then assembled and subjected to power generation evaluation in the same manner as that of Example 1.

Test Results

Table 1 shows the pressure loss values for the anode gas and cathode gas of the Examples and Comparative Example during power generation at a current density of 0.3 A/cm², a hydrogen utilization factor of 0.6 and an oxygen utilization factor of 0.4. Compared with the Comparative Example, the Examples show a dramatic reduction in pressure loss for both the anode and the cathode. This is a result of the fact that while the Comparative Example had only one pair of manifolds and thus only one gas distribution channel, the Examples comprised a plurality of manifolds and thus two gas distribution channels in the cell, whereby the gas amount per distribution channel was halved. This allowed the gas flow rate to be reduced at the gas turn-around portions, which particularly add to pressure loss. Cell pressure loss reduction enables the blow pressure of the blower or similar apparatus to be reduced, whereby a low-ancillary equipment loss can be realized and system efficiency can be improved.

TABLE 1

Pressure loss (kPa)

| | Cathode | Anode |
|---|---|---|
| Example 1 | 3.0 | 1.2 |
| Example 2 | 2.5 | 0.8 |
| Example 3 | 2.5 | 0.8 |
| Example 4 | 2.5 | 1.5 |
| Example 5 | 2.2 | 1.3 |
| Comparative | 6.5 | 3.2 |
| Example | | |

Table 2 shows the hydrogen utilization factor that was required for the Examples to realize a current density of 0.3 A/cm² and a cell voltage of 0.7 V. While the value for Example 1 is 0.6, Example 2 improves to a utilization factor of 0.7. An increase in the utilization factor is indicative of an improvement in fuel cell performance, since the gas amount supplied to the cell is decreased. The improvement shown in Example 2 is thought to be because Example 1 comprised three (an odd number) turn-around portions, whereby gas flowing through the shortest distance of the folds increased. This caused a bias in the gas amount in the gas channel portions following the folds, thereby making the reaction distribution uneven on the fuel cell surface, whereby a high hydrogen utilization factor power generation could not be achieved. On the other hand, it is thought that for Example 2, which had its number of folds set to an even number, in view of its structure had an even pressure loss in the folds and the following gas channels, whereby gas flowed evenly. This caused the electrode reaction to be even, thereby improving the hydrogen utilization-factor.

TABLE 2

| | Hydrogen utilization factor (−) |
|---|---|
| Example 1 | 0.60 |
| Example 2 | 0.70 |
| Example 3 | 0.85 |
| Example 4 | 0.93 |
| Example 5 | 0.93 |

The hydrogen utilization factor of Example 3 shown in Table 2 was 0.85, which is even more improved than that of Example 2. This is because Example 2 had a structure in which the distribution gas channel r₁ and the separate gas channel r′ₙ₊₁ were adjacent to each other, whereby there existed gas which was discharged without contributing to power generation due to the fact that reaction gas flowing though r₁ flowed into the r′ₙ₊₁ gas channel. On the other hand, in Example 3 it is thought that the hydrogen concentration in the adjacent rₙ₊₁ and r′ₙ₊₁ gas channels was reduced from being consumed in power generation, so that even if gas inflow did occur its effect on fuel cell performance was minor, thus enabling a high hydrogen utilization factor power generation to be achieved.

Table 3 shows the temperature of the electrode central portion during power generation. The temperature for Example 2 was 79° C., while the temperature for Example 3 decreased to 73° C. This was because a distribution channel for supplying reaction gas from the central portion was present in Example 2, whereas in Example 3 the reaction gas were supplied from an exterior side of the electrode. This means that while the portion in Example 2 that had the highest reaction rate was the central portion, in Example 3 this portion was located at the periphery. Heat dissipation is large at an electrode peripheral portion, where temperature control is comparatively easy. In contrast, heat is not easily dissipated from the fuel cell central portion, whereby the fuel cell interior is susceptible to becoming hot. Since exposing a fuel cell material, especially the electrolyte membrane, to high temperatures advances degradation, Example 3 is preferable to Example 2 for generating power stably over a long period of time.

TABLE 3

| | Fuel cell temperature (° C.) |
|---|---|
| Example 1 | 79 |
| Example 2 | 79 |
| Example 3 | 73 |
| Example 4 | 73 |
| Example 5 | 73 |

According to Table 2, the hydrogen utilization factor of Example was 0.93, which is greater than that of Example 3. This is thought to result from the fact that, in the gas channel structure of the anode separator in Example 4, since 3 turn-around portions per distribution channel, for a total of 6 turn-around portions, were formed on the frame, the gas channel cross-sectional area of the anode gas channel was diminished. This increased the flow rate, whereby gas diffusion of the condensed water generated along with the reaction proceeding could be rapidly discharged outside of the cell without being obstructed, thus increasing the stability of fuel cell performance. Although the anode gas pressure loss would tend to increase due to the gas channel cross-sectional area diminishment, the pressure loss value during power generation for Example 4 was 1.5 kPa, which is absolutely a sufficiently low value. In this range, improving the hydrogen utilization factor has a greater effect in improving overall system performance than the pressure loss increase.

Table 4 shows the power generation time and the voltage drop percentage from the initial voltage value for Example 4 and Example 5 after continuous power generation at a current density of 0.3 A/cm², an anode gas hydrogen concentration of 0.5, a hydrogen utilization factor of 0.85, an oxygen utilization factor of 0.4, and a fuel cell temperature of 70° C. Although in Example 4 the voltage drop percentage for a continuous power generation time of 5000 hours reached 10%, for Example 5 a drop of 5% or less was measured after a continuous power generation time of 9000 hours, thus illustrating stability.

TABLE 4

| | Power generation | Voltage drop |
|---|---|---|
| | time (hours) | percentaqe (−) |
| Example 4 | 5,000 | 0.1 |
| Example 5 | 9,000 | 0.05 or less |

In Example 4, the separator was disposed perpendicularly, wherein of the 2 distribution channels which constitute the gas channel, one always comprised a portion flowing upwards with respect to the direction of gravity. If the gas channel is set to face upwards, because the condensed moisture must be discharged externally from the cell against gravity, the moisture tends to accumulate in the fuel cell gas channels. Accumulated moisture can be an unstable factor regarding fuel cell performance. For example, when moisture that has accumulated at an aperture vicinity is intermittently discharged by the flow of gas, fuel cell performance can increase and decrease depending on the cycle with which water is discharged due to fluctuations in the gas pressure.

In such a case, taking into account the reaction situation on the electrode surface, when the voltage decreases there is the possibility that the diffusion of gas was insufficient due to the accumulation of water, whereby the electrode reaction is proceeding in a state wherein a reactive species is in short supply. When the accumulated water is momentarily discharged and the gas diffusion becomes satisfactory, the reaction will proceed at the reaction field at which the electrode reaction had been reduced until that point. If a cycle such as this is repeated, partial sudden load application is caused, whereby the deterioration of the electrode material becomes marked. The rate of fuel cell performance deterioration will increase over time from the above mechanism.

However, since in Example 5 the electrode gas channels are designed to be horizontal, there are no portions in the two distribution channels wherein the gas faces upwards with respect to gravity. Furthermore, because the direction of the discharge manifold into which gas flows into from the gas channel can be set in the direction of gravity, moisture discharge from the fuel cell is easier than in Example 4. For this reason, gas diffusion variation in the cell resulting from electrode deterioration such as that in Example 4 is suppressed, to thereby suppress deterioration of the electrode material. As a consequence, it was possible to improve the voltage drop percentage in Example 5 as compared with Example 4.

From the evaluated results of the Comparative Example and the Examples, examination was carried out into the separator structure and gas pressure loss value during use of the metal separator, the hydrogen fuel utilization factor during constant current power generation, fuel cell central portion temperature during power generation and the effects of voltage on deterioration rate over time. From these results, it was learned that according to the present invention gas pressure loss can be reduced and fuel cell performance can be improved.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell constituted by laminating a plurality of units, the units combining a first metal gas channel plate having on both faces a frame portion and a plurality of gas channel sets formed inside the frame portion, a first frame having a supply manifold for supplying reaction gas to an end turn-around portion of the gas channels closely attached to the frame portion of the metal gas channel plate and a discharge manifold for discharging reaction gas, a first reaction gas diffusion layer in contact with said frame, an electrolyte membrane which is in contact with the first reaction gas diffusion layer and in which one side is in contact with an anode and another side in contact with a cathode, a second reaction gas diffusion layer in contact with the anode or the cathode, a second frame in contact with the second reaction gas diffusion layer, and a second metal gas channel plate in contact with the second frame and which has a supply manifold and a discharge manifold, wherein a plurality of supply manifolds and/or discharge manifolds are provided per each frame.

2. The fuel cell according to claim 1, wherein the supply manifold is, when viewed with the gas channel sets in a flat plane, formed on a same gas channel edge side and separately on the left and right therefrom.

3. The fuel cell according to claim 1, wherein the supply manifold is located in a roughly central portion of the gas channel plate, and the discharge manifold is formed on an opposite side of the supply manifold, and when viewed with the gas channel sets in a flat plane, formed separately on the left and right therefrom.

4. The fuel cell according to claim 1, wherein a plurality of supply manifolds are formed on a same gas channel edge, and a plurality of discharge manifolds are formed on an opposite side to the gas channel edge.

5. The fuel cell according to claim 1, wherein all the supply manifold and the discharge manifold are both formed on the same gas channel edge.

6. A fuel cell comprising a metal separator, which comprises a metal gas channel plate formed by pressing a metal plate to have a plurality of substantially linear gas channel sets and a frame closely attached to the metal gas channel plate having a gas channel for distributing gas at a gas channel edge, a diffusion layer for diffusing supplied reaction gas to an anode or a cathode, and an electrolyte membrane formed having the anode and the cathode on a front and back surface thereof, the frame comprising a supply manifold and a discharge manifold for supplying reaction gas to the gas channels and discharging reaction gas from the gas channels, wherein the fuel cell employs a metal separator formed using a frame in which a number Nf of supply manifolds for supplying reaction gas to the metal gas channel plate is defined by Nf=2n where n is a natural number.

7. The fuel cell according to claim 6, wherein a gas turn-around portion formed on the frame which is closely attached to the metal separator spatially connects gas channel ends with the ends of a plurality of separate adjacent linear ridge/groove-shaped gas channels for conducting reaction gas flowing through the gas channels to adjacent plurality of gas channels, and a metal separator is employed in which a number of turn-around portions Nt is defined by Nt=2m per separator where m is a natural number.

8. The fuel cell according to claim 6 or 7, wherein a metal separator is employed in which a number Nfi of supply manifolds for supplying reaction gas to linear ridge/groove-shaped gas channels of the metal gas channel plate is, with respect to a number Nfo of manifolds for discharging gas from the linear ridge/groove-shaped gas channels, defined by Nfi−Nfo≧1.

9. The fuel cell according to any of claims 6 to 8, wherein a metal separator is employed in which a number Nta of turn-around portions per separator formed on an anode gas channel and a number Ntc of turn-around portions per separator formed on a cathode gas channel is such that Nta>Ntc.

10. The fuel cell according to any of claims 6 to 9, wherein the linear ridge/groove-shaped gas channels formed on the metal gas channel plate which constitutes the metal separator are disposed horizontally at least during power generation.

11. A separator for a fuel cell comprising a metal gas channel plate having on both faces a frame portion and a plurality of gas channel sets formed inside the frame portion, and a frame having a supply manifold for supplying reaction gas to an end turn-around portion of the gas channels closely attached to the frame portion of the metal gas channel plate and to the gas channels and a discharge manifold for discharging reaction gas, wherein a plurality of supply manifolds and/or discharge manifolds are provided per each frame.

12. The separator for a fuel cell according to claim 11, wherein the supply manifold is, when viewed with the gas channel sets in a flat plane, formed on a same gas channel edge side and separately on the left and right therefrom.

13. The separator for a fuel cell according to claim 11, wherein the supply manifold is located in a roughly central portion of the gas channel plate, and the discharge manifold is formed on an opposite side of the supply manifold, and when viewed with the gas channel sets in a flat plane, formed separately on the left and right therefrom.

14. The separator for a fuel cell according to claim 11, wherein a plurality of supply manifolds are formed on a same gas channel edge, and a plurality of discharge manifolds are formed on an opposite side to such gas channel edge.

15. The separator for a fuel cell according to claim 11, wherein the supply manifold and the discharge manifold are both formed on the same gas channel edge.

16. A kit for a fuel cell comprising a metal gas channel plate having on both faces a frame portion and a plurality of gas channel sets formed inside the frame portion, a frame having a supply manifold for supplying reaction gas to an edge turn-around portion of the gas channels closely attached to the frame portion of the metal gas channel plate and to the gas channels and a discharge manifold for discharging reaction gas, a reaction gas diffusion layer, and a membrane electrode assembly which has an electrolyte membrane in contact with an anode on one side and a cathode on another side, wherein a plurality of supply manifolds and/or discharge manifolds are provided per each frame.

17. The kit for a fuel cell according to claim 16, wherein the supply manifold is, when viewed with the gas channel sets in a flat plane, formed on a same gas channel edge side and separately on the left and right therefrom.

18. The kit for a fuel cell according to claim 16, wherein the supply manifold is located in a roughly central portion of the gas channel plate, and the discharge manifold is formed on an opposite side of the supply manifold, and when viewed with the gas channel sets in a flat plane, formed separately on the left and right therefrom.

19. The kit for a fuel cell according to claim 16, wherein a plurality of supply manifolds are formed on a same gas channel edge, and a plurality of discharge manifolds are formed on an opposite side to such gas channel edge.

20. The kit for a fuel cell according to claim 16, wherein the supply manifold and the discharge manifold are both formed on the same gas channel edge.
